(19) United States
(12) Patent Application Publication
(10) Pub. No.: US 2023/0258032 A1
(43) Pub. Date: Aug. 17, 2023

(54) FURNITURE FITTING COMPRISING A MULTI-JOINT MECHANISM

(71) Applicant: Julius Blum GmbH, Hoechst (AT)

(72) Inventors: Dominik GABL, Bludenz (AT); Sarah SCHEFFKNECHT, Krumbach (AT); Simon LUBETZ, Hoechst (AT); Tobias HINTEREGGER, Wolfurt (AT)

(21) Appl. No.: 18/130,057

(22) Filed: Apr. 3, 2023

Related U.S. Application Data
(63) Continuation of application No. PCT/AT2021/060378, filed on Oct. 15, 2021.

(30) Foreign Application Priority Data
Oct. 22, 2020 (AT) A 50907/2020

(51) Int. Cl. E05D 3/14

(52) U.S. Cl. CPC E05D 3/14; E05Y 2900/20

(57) ABSTRACT

A furniture fitting for movably mounting a furniture flap, in particular a two-part furniture flap, on a furniture carcass includes a main part which is or can be connected to the furniture carcass; a mounting device which is or can be connected to the furniture flap; and at least one, in particular exactly one, actuating arm which is mounted or can be mounted on the main part at a first end so as to be pivotable about an axis of rotation. The actuating arm is or can be connected to the mounting device at a second end opposite the first end via at least one multi-joint mechanism, and the multi-joint mechanism has at least three, preferably at least four, particularly preferably exactly four, joints each having an axis of rotation.

### BACKGROUND OF THE INVENTION

The invention relates to a furniture fitting for movably mounting an in particular two-part furniture flap on a furniture carcass. The invention furthermore relates to a piece of furniture comprising such a furniture fitting.

Furniture fittings of the above-mentioned type are already known in many different embodiments in the state of the art.

The specification AT 413 418 B is to be mentioned here as exemplary state of the art. FIGS. 1a, b and FIGS. 2a, b of the present application show an embodiment of the invention in AT 413 418 B. FIGS. 1a, b show the piece of furniture with a closed furniture flap, wherein FIG. 1b represents a detailed view of FIG. 1a. FIGS. 2a, b show the piece of furniture with an open furniture flap, wherein FIG. 2b represents a detailed view of FIG. 2a.

The piece of furniture 1 with a furniture fitting shown here has a two-part furniture flap 2, wherein the first flap part 21 is typically arranged at the top in the installed position and the second flap part 22 is arranged at the bottom in the installed position. The first flap part 21 and the second flap part 22 are rotatably connected via a flap-to-flap hinge 7. The first flap part 21 is additionally rotatably connected to the furniture carcass 11 of the piece of furniture 1 via a carcass-to-flap hinge 9.

The piece of furniture 1 has at least one – in particular two – furniture fittings with at least one –in particular exactly one – actuating arm 3. This actuating arm 3 is rotatably connected to the furniture carcass 11, in particular the furniture side wall 12 (not visible from FIGS. 1a, b and FIGS. 2a, b).

In addition, the at least one furniture fitting has an actuating arm-to-flap hinge 8, wherein the actuating arm-to-flap hinge 8 rotatably connects the actuating arm 3 to the second flap part 22. The connection is arranged below the flap-to-flap hinge 7, in particular in the region of the lower edge 23 of the second flap part 22.

Here, the hinges are each formed as hinges with a revolute joint and one axis of rotation, wherein all axes of rotation are arranged parallel to each other. The axes of rotation of the four hinges thus form four edges of a rectangle, which deforms during opening and closing. In the closed position (FIGS. 1a, b), the rectangle is “extended”, whereas in the open position (FIGS. 2a, b) the rectangle has a larger surface area.

A known disadvantage of such furniture flaps 2 (also known from a large number of further specifications) is the bending in the region of the flap-to-flap hinge 7 in a substantially closed position of the furniture flap. As the rectangle formed by the revolute joints is almost fully extended here, the flap-to-flap hinge can bend in the “wrong” direction, namely in the direction of the furniture carcass 11.

This is problematic because, in the case of a bent furniture flap 2, the opening movement of the furniture flap 2 is blocked. In order to make an opening movement of the furniture flap 2 possible, the bending must first be reversed.

A bending of the furniture flap 2 occurs in particular when a user pulls outwards (away from the furniture carcass 11) on the lower edge 23 of the second flap part 22, as is normal in the case of usual pieces of furniture with a one-part flap.

AT 413 418 B partially solves this problem. The axis of rotation 71 of the flap-to-flap hinge 7 is arranged in the region of the wall thickness S of the upper flap part 21, which is why the flap-to-flap hinge 7 has a hinge cup 72. In addition, a socket 74 is provided on the hinge arm 73, which connects the first flap part 21 and the second flap part 22 to each other. In the case of a closed furniture flap 2, the socket 74 rests against the first flap part 21, in particular against the hinge cup 72.

The flap-to-flap hinge 7 is partially prevented from bending by striking the socket 74.

A disadvantage of this state of the art is that the position of the socket 74 is very critical. If the limit stop of the socket 74 is displaced only a little in the direction of the interior of the furniture carcass 11, the furniture flap 2 is not prevented from bending and the problems described above persist. If the limit stop of the socket 74 is displaced only a little in a direction pointing outwards from the furniture carcass 11, the furniture flap 2 no longer closes fully. Objects can therefore fall out of the piece of furniture 1 and it no longer has an aesthetic, uniform furniture front.

This set of facts demands an exact setting of the flap-to-flap hinge 7 and a high dimensional stability of all involved materials. High demands are thus placed on the designer and on the installer.

### SUMMARY OF THE INVENTION

Starting from this state of the art, an object of the present invention is to create a furniture fitting, and a piece of furniture with this furniture fitting, which at least partly overcomes or reduces the previously described disadvantages.

In particular, it is intended to create a furniture fitting for a piece of furniture which largely prevents the furniture flap from bending.

A furniture fitting according to the invention for movably mounting an in particular two-part furniture flap on a furniture carcass comprises a main body which is or can be connected to the furniture carcass, a mounting device which is or can be connected to the furniture flap and at least one, in particular exactly one, actuating arm which is or can be mounted on the main body at a first end pivotable about an axis of rotation.

According to the invention, the at least one actuating arm is or can be connected to the mounting device at a second end opposite the first end via at least one multi-joint mechanism, and the at least one multi-joint mechanism has at least three, preferably exactly four, joints each having one axis of rotation.

Through the use of a multi-joint mechanism with more than one joint instead of a single-joint flap-to-flap hinge, as is disclosed in the state of the art, the instantaneous center of rotation, thus the projection of the current virtual axis of rotation, of a movement of the furniture flap can be chosen using the geometry of the multi-joint mechanism.

In the case of a substantially closed furniture flap, in a reference system of a resting actuating arm, the instantaneous center of rotation of the opening movement of the furniture flap can thus be displaced further into the interior of the furniture carcass or even behind the furniture carcass.

As the distance between the (virtual) axis of rotation and the furniture flap increases, the movement of the furniture flap has an increasingly large (vertical) translational component and an increasingly small rotational component. If the distance is large enough, the bending of the furniture flap, which corresponds to a rotational movement, is kinematically prevented or at least reduced.

Because the bending is prevented in a purely kinematic way, an exact setting of a socket limit stop is not necessary.

In an embodiment, the axes of rotation of the at least three joints are aligned parallel to each other.

The at least one multi-joint mechanism has at least two, preferably exactly two, connecting linkages, and the at least one actuating arm is connected to the mounting device in an articulated manner by the at least two connecting linkages. The kinematics of the furniture flap, in particular the movement path of the instantaneous center of rotation, can be set with the choice of the arrangement of the at least two connecting linkages.

It is envisaged that the at least one multi-joint mechanism has a first connecting linkage and a second connecting linkage, wherein:
a first joint connects the at least one actuating arm to the first connecting linkage, and/or
a second joint connects the at least one actuating arm to the second connecting linkage, and/or
a third joint connects the mounting device to the first connecting linkage, and/or
a fourth joint connects the mounting device to the second connecting linkage.

The at least one actuating arm is thus connected to the mounting device, for example, via a four-joint mechanism.

The furniture fitting can be formed such that:
in the case of a first – preferably extended – position of the at least one multi-joint mechanism, in the reference system of a resting actuating arm, an instantaneous center of rotation of the movement of the mounting device lies outside the at least one multi-joint mechanism in the installed position of the at least one furniture fitting, in particular in the interior of the furniture carcass, preferably in the rear two-thirds of the furniture carcass, particularly preferably in the rear third of the furniture carcass, or behind the furniture carcass, and/or
in the case of a second – preferably folded – position of the at least one multi-joint mechanism, in the reference system of a resting actuating arm, an instantaneous center of rotation of the movement of the mounting device lies in the region of the at least one multi-joint mechanism.

The instantaneous center of rotation corresponds to the projection of the virtual axis of rotation. The virtual axis of rotation can be constructed by the intersection of the two planes which run through the axes of rotation of the first joint and the third joint or the second joint and the fourth joint.

Because the instantaneous center of rotation lies outside the at least one multi-joint mechanism, in particular deep in the interior of the furniture carcass or behind the furniture carcass in the case of a first – preferably extended – position of the furniture fitting, which the furniture fitting preferably adopts in a substantially closed position of the furniture flap, the furniture flap has a lower tendency to bend.

Because the instantaneous center of rotation lies in the region of the at least one multi-joint mechanism in the case of a second – preferably folded – position of the furniture fitting, which the furniture fitting preferably adopts in a substantially open position of the furniture flap, the multi-joint mechanism behaves like a single-joint hinge in the case of a substantially open position of the furniture flap.

The at least one mounting device can have an installation plane, wherein a furniture flap can be installed on the installation plane. The installation plane corresponds to the plane of the inside of the furniture flap in the installed state.

In the reference system of a resting actuating arm, the instantaneous center of rotation of the movement of the mounting device is arranged on a first side of the installation plane. The at least one actuating arm and/or the at least one multi-joint mechanism is/are likewise arranged on the first side of the installation plane. This is preferably the case in the case of a first – preferably extended – position and in the case of a second – preferably folded – position, in particular in the case of all positions, of the at least one multi-joint mechanism.

In an embodiment, the at least one actuating arm comprises a connecting part, wherein the at least one multi-joint mechanism is connected to the at least one actuating arm via the connecting part. The multi-joint mechanism can thus be installed on and removed from the actuating arm together with the connecting part.

The at least one actuating arm can be detachably connected to the main body. For this, a main body connecting part is preferably provided, which can be connected to the guide sleeve of the at least one actuating arm and can be locked to the main body. The at least one actuating arm can thus be easily connected to the main body, which can already be pre-installed on the furniture carcass.

The at least one multi-joint mechanism comprises at least two connecting linkages, wherein the at least two connecting linkages each comprise at least one – preferably exactly two – levers and in particular the at least one lever has at least two drilled holes. Thus, one connecting linkage can, for example, comprise two levers.

In an embodiment:
a first joint of the at least one multi-joint mechanism is formed as a drilled hole in the connecting part, a drilled hole in the at least one lever of the first connecting linkage and a pin, and/or
a second joint of the at least one multi-joint mechanism is formed as a drilled hole in the connecting part, a drilled hole in the at least one lever of the second connecting linkage and a pin, and/or
a third joint of the at least one multi-joint mechanism is formed as a drilled hole in the mounting device, a drilled hole in the at least one lever of the first connecting linkage and a pin, and/or
a fourth joint of the at least one multi-joint mechanism is formed as a drilled hole in the mounting device, a drilled hole in the at least one lever of the second connecting linkage and a pin.

In an embodiment, the at least one actuating arm has a connecting part and the at least one multi-joint mechanism has at least two connecting linkages. The at least two connecting linkages comprise at least two – preferably exactly two – levers, and the connecting part and/or the mounting device is/are arranged between the two levers of the at least two connecting linkages, preferably between the two levers of the at least two connecting linkages in the direction of the axes of rotation. A stable multi-joint mechanism can thus be realized.

The at least one actuating arm can be adjustable in length, preferably wherein:
the length of the at least one actuating arm is fixable in particular by a catch function and/or by a frictional part, in particular in combination with a spring element exerting pressure on the frictional part, and/or by locking, in particular by means of at least one screw, and/or
the length of the at least one actuating arm is changeable during the opening and/or closing movement of the furniture flap, and/or
the at least one actuating arm has a guide sleeve and a piston, wherein the piston is displaceable in the guide sleeve, and/or
the at least one actuating arm has a connecting part, wherein the connecting part is displaceable relative to the rest of the at least one actuating arm.

For one thing, the length adjustability can be utilized during the installation and setting of the furniture fitting in order to adapt the at least one actuating arm to the dimensions of the piece of furniture, in particular the furniture flap.

During operation, the length of the at least one actuating arm can be locked.

However, it can also be envisaged that the length of the actuating arm changes telescopically during the opening and/or closing movement.

A torque can be applicable to the at least one actuating arm, preferably wherein:
an electric drive unit and/or
a mechanical energy storage device
is provided in the main body for this purpose. This simplifies the operation of the furniture flap.

The torque can depends on the actuating angle of the at least one actuating arm. The torque can thus, for example, always be chosen such that it compensates for the weight force of the furniture flap. The furniture flap can thus be held in every position.

It is additionally envisaged that the electric drive unit can be actuated via a wireless or wired connection.

A piece of furniture with a furniture carcass, at least one, in particular two-part, furniture flap and at least one furniture fitting is provided, wherein the at least one mounting device is installed on the at least one furniture flap, and wherein the at least one main body is connected to the furniture carcass and the at least one actuating arm is connected to the at least one mounting device by means of the at least one multi-joint mechanism.

The furniture flap can thus be held by the at least one actuating arm, and the kinematics of the furniture flap can be set by the dimensions of the multi-joint mechanism. In particular, the kinematics can be chosen such that a bending is prevented in the case of a substantially closed furniture flap.

In an embodiment, the at least one furniture flap comprises a first flap part – preferably arranged at the top in the installed position – and a second flap part – preferably arranged at the bottom in the installed position, wherein:
the first flap part is connected to the furniture carcass in an articulated manner, and
the first flap part is connected to the second flap part in an articulated manner.

A folding flap realized thereby has the advantage that less space is needed above the piece of furniture.

The at least one mounting device can be installed on the second flap part, and the at least one actuating arm is connected to the second flap part by the at least one multi-joint mechanism, preferably leaving out the first flap part.

An embodiment is characterized in that:
in a substantially closed position of the at least one furniture flap, the at least one actuating arm is substantially parallel to the first flap part and to the second flap part, and/or
in a substantially open position of the at least one furniture flap, the at least one actuating arm is at an angle of from 45° to 135° to the second flap part.

The piece of furniture can thus be formed such that:
in a substantially closed position of the at least one furniture flap, in the reference system of a resting actuating arm, an instantaneous center of rotation of the opening movement of the second flap part lies in the interior of the furniture carcass, preferably in the rear two-thirds of the furniture carcass, particularly preferably in the rear third of the furniture carcass, or behind the furniture carcass, in particular lies outside the at least one multi-joint mechanism, and/or
in a substantially open position of the furniture flap, in the reference system of a resting actuating arm, an instantaneous center of rotation of the closing movement of the second flap part lies in the region of the at least one multi-joint mechanism.

The multi-joint mechanism thus behaves like a single-joint hinge in the case of a substantially open position of the furniture flap.

In the case of a substantially closed position of the furniture flap, the virtual axis of rotation (or the instantaneous center of rotation) of the furniture flap lies outside the multi-joint mechanism, as a result of which the movement of the furniture flap has a larger translational component. This prevents the furniture flap from bending.

### BRIEF DESCRIPTION OF THE DRAWINGS

Further details and advantages of the invention are explained in more detail below by the description of the figures with reference to the drawings, in which:

FIGS. 1a, b show a piece of furniture with a closed furniture flap and furniture fitting according to the state of the art, a. side view, b. detailed view of the flap-to-flap joint,

FIGS. 2a, b show piece of furniture with an open furniture flap and furniture fitting according to the state of the art, a. side view, b. detailed view of the flap-to-flap joint,

FIG. 3 is a schematic drawing of the engagement of the actuating arm on the furniture flap by means of a single-joint hinge according to the state of the art,

FIG. 4 is a schematic drawing of the engagement of the actuating arm on the furniture flap by means of a multi-joint mechanism according to an embodiment of the present invention,

FIG. 5 is a sectional representation of a piece of furniture with a furniture fitting,

FIG. 6 shows a furniture fitting in isolation,

FIGS. 7a-d show various positions of the multi-joint mechanism, a. extended position in the case of a closed furniture flap, b. and c. folded intermediate positions, d. folded position in the case of an open furniture flap,

FIGS. 8a, b are side views of the furniture fitting in a. an extended position and b. a folded position,

FIGS. 9a, b are perspective representations of the furniture fitting in a folded position, and

FIG. 10 is an exploded representation of the furniture fitting

### DETAILED DESCRIPTION OF THE INVENTION

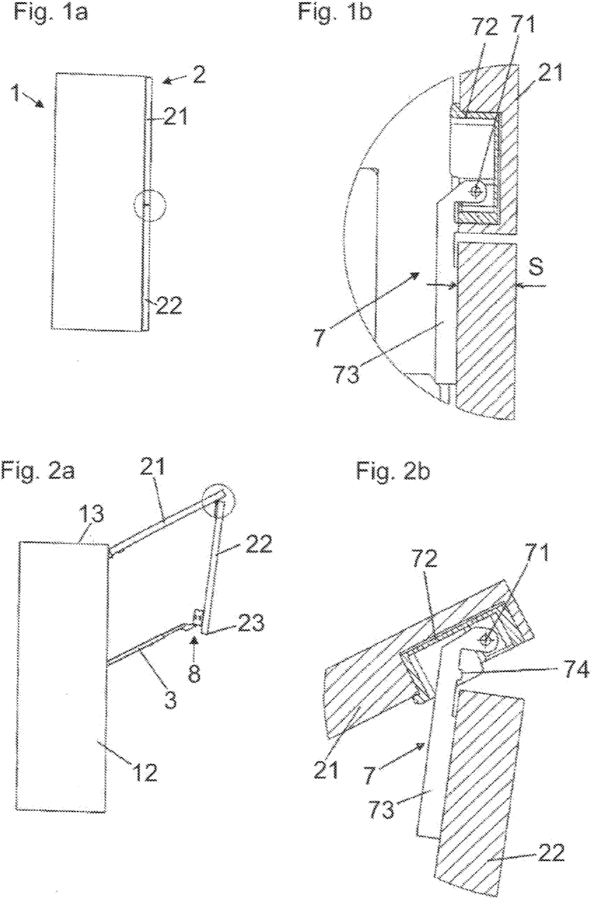

The state of the art from FIGS. 1a, b and FIGS. 2a, b has already been discussed above in the introduction to the description.

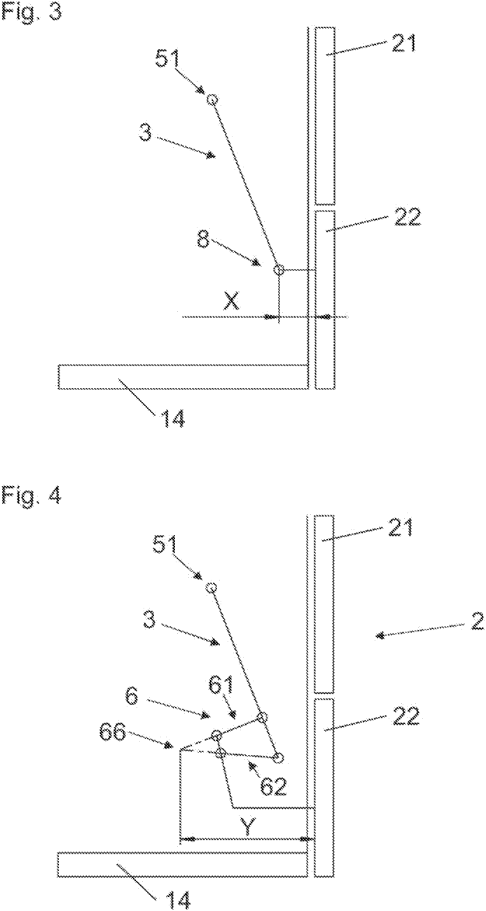

FIG. 3 shows a schematic representation of a piece of furniture with a furniture flap 2 having a first flap part 21 and a second flap part 22 with a realization of the engagement of the actuating arm 3 on the furniture flap 2 common in the state of the art.

The actuating arm 3 is rotatably connected to the furniture carcass 11 by means of an actuating arm joint 51 in a main body 5 (not represented here). Here, merely the axis of rotation of the hinge is indicated (in the projection). The axis of rotation of a single-joint actuating arm-to-flap hinge 8 is represented at the opposite end of the actuating arm 3. The actuating arm 3 is rotatably connected to the second flap part 22 via the actuating arm-to-flap hinge 8.

In a reference system with a resting actuating arm 3, the movement of the second flap part 22, for example during opening or closing of the furniture flap 2, is limited to a rotation about the axis of rotation of the actuating arm-to-flap hinge 8.

The axis of rotation is arranged at a distance X away from the second flap part 22. Because the axis of rotation is not arranged in the second flap part 22, in a reference system with a resting actuating arm 3, the movement of the second flap part 22 does not correspond to a pure rotational movement but also includes a translational component. The larger the distance X is, the greater the translational component is in relation to the rotational component. (For X tending towards infinity, the movement of the second flap part 22 would correspond to a translational movement with a vanishing rotational component).

In the case of a substantially closed furniture flap 2, the translational component of the movement of the second flap part 22 leads to a substantially vertical movement of the second flap part 22. A bending of the second flap part 22 in the region of the flap-to-flap hinge 7 corresponds to a rotational movement of the second flap part 22.

If the axis of rotation of the second flap part 22 is displaced further into the furniture carcass 11, thus if the distance X is increased, the tendency of the second flap part 22 to bend in the region of the flap-to-flap hinge 7 is also reduced.

In a design according to the state of the art in FIG. 3, the distance X cannot be increased at will.

For example, the distance X can be at most 40 millimetres or at most 50 millimetres.

That is to say an increase in the distance X necessarily leads to the actuating arm-to-flap hinge 8 also being spaced further apart from the second flap part 22. The actuating arm 3 is thus also arranged further in the interior of the furniture carcass 11. This reduces the space in the furniture carcass 11 and can result in a collision of the actuating arm-to-flap hinge 8 and/or the actuating arm 3 with intermediate shelves or other objects in the furniture carcass 11.

FIG. 4 shows a schematic representation of an embodiment of the piece of furniture 1 according to the invention. Here, the single-joint actuating arm-to-flap hinge 8 is replaced by a multi-joint mechanism 6.

In the embodiment in FIG. 4, the multi-joint mechanism 6 has four joints.

Multi-joint mechanisms have a virtual axis of rotation, which typically does not coincide with one of the axes of rotation of the (four) joints. Depending on the position of the multi-joint mechanism 6, the virtual axis of rotation is arranged at a different position; in the case of a movement of the hinge, the virtual axis of rotation “moves” on a path predefined by the geometry of the multi-joint mechanism 6.

The virtual axis of rotation projected onto a plane that is orthogonal to the axis of rotation is called the instantaneous center of rotation 66 of the movement.

In FIG. 4, in a reference system with a resting actuating arm 3 and in the case of a closed furniture flap 2, the instantaneous center of rotation 66 of the movement of the second partial flap 22 is arranged at a distance Y from the second partial flap 22.

The geometric design of the instantaneous center of rotation 66 is effected by intersecting the two imaginary straight lines which run through the axes of rotation of the joints of the connecting linkages 61, 62.

As can be seen from FIG. 4, the distance Y can be changed by the geometric shape of the multi-joint mechanism 6. In particular, it is to be mentioned here that the instantaneous center of rotation 66 is arranged further in the interior of the furniture carcass 11 than the multi-joint mechanism 6 itself.

The distance Y and the distance of the multi-joint mechanism 6 from the second partial flap 22 can thus be designed independently of each other up to a certain degree. This possibility does not exist in the case of the state of the art in FIG. 3.

For example, the distance Y can be greater than 80 millimetres or greater than 70 millimetres.

The distance Y can be so large that the instantaneous center of rotation 66 is arranged within the rear two-thirds or in the rear third of the furniture carcass 11. The instantaneous center of rotation 66 can also be arranged behind the furniture carcass 11.

A large distance Y results in a large translational component in relation to the rotational component of the movement of the second flap part 22 in a reference system with a resting actuating arm 3. The tendency to bend is thus reduced kinematically through the design of a multi-joint mechanism.

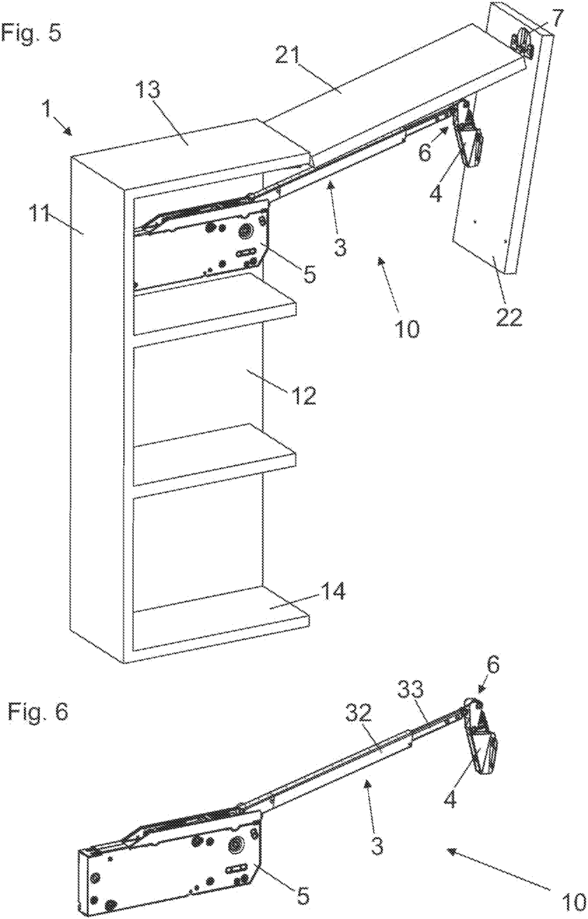

FIG. 5 shows a sectional representation of a piece of furniture 1 with a furniture carcass 11, a two-part furniture flap 2 and a furniture fitting 10, wherein the mounting device 4 is installed on the at least one furniture flap 2, and wherein the main body 5 is connected to the furniture carcass 11 and an actuating arm 3 is connected to the at least one mounting device 4 by means of a multi-joint mechanism 6.

The furniture carcass 11 comprises a top panel 13 and a base 14. A furniture side wall 12, on which the main body 5 is installed, is also shown.

Typically, for the movable mounting of a furniture flap 2, two furniture fittings 10 are installed, as is also the case in the state of the art.

The furniture flap 2 comprises a first flap part 21 – arranged at the top in the installed position –and a second flap part 22 – arranged at the bottom in the installed position, wherein the first flap part 21 is connected to the furniture carcass 11 in an articulated manner and the first flap part 21 is connected to the second flap part 22 in an articulated manner.

The mounting device 4 of the furniture fitting 10 is installed on the second flap part 22, wherein the actuating arm 3 is connected to the second flap part 22 by means of the multi-joint mechanism 6, leaving out the first flap part 21.

In a substantially open position of the at least one furniture flap 2, the actuating arm 3 is at an angle of from 45° to 135° to the second flap part 22.

In a substantially closed position of the at least one furniture flap 2, the actuating arm 3 is substantially parallel to the first flap part 21 and to the second flap part 22. This is not shown in FIG. 5.

FIG. 6 shows the furniture fitting 10 from FIG. 5 in isolation. The furniture fitting for movably mounting an in particular two-part furniture flap 2 on a furniture carcass 11 comprises a main body 5 which is or can be connected to the furniture carcass 11, a mounting device 4 which is or can be connected to the furniture flap 2 and an actuating arm 3 which is or can be mounted on the main body 5 at a first end pivotable about an axis of rotation.

The actuating arm 3 is or can be connected to the mounting device 4 at a second end opposite the first end via at least one multi-joint mechanism 6, wherein the at least one multi-joint mechanism 6 has four joints 611, 612, 621, 622 each having one axis of rotation.

The actuating arm 3 has a guide sleeve 32 and a piston 33, wherein the piston 33 is displaceable in the guide sleeve 32. The actuating arm 3 is thus designed adjustable in length.

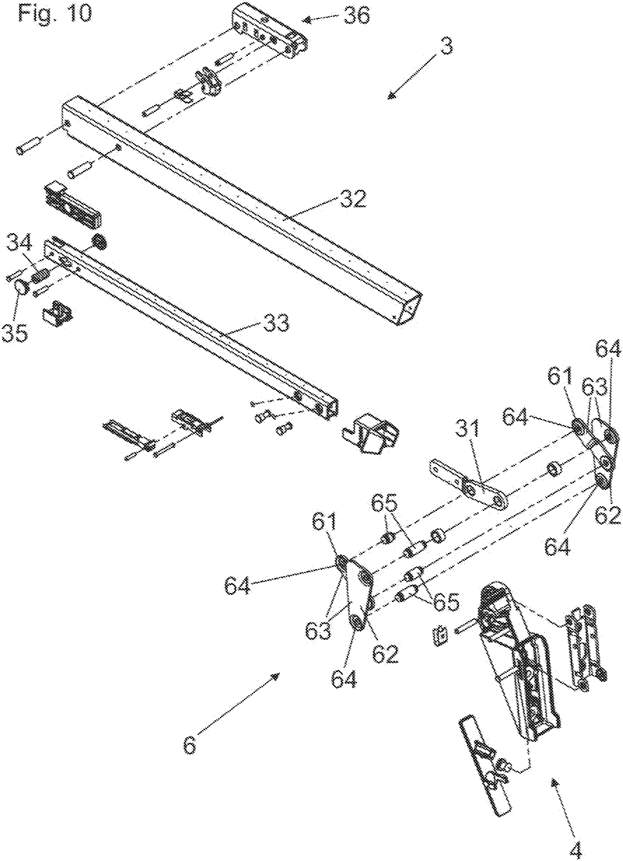

The length of the actuating arm 3 can be fixable by a catch function and/or by a frictional part 35, in particular in combination with a spring element 34 exerting pressure on the frictional part 35 (see FIG. 10), and/or by locking, in particular by at least one screw.

The length of the actuating arm 3 can be dynamically changeable during the opening and/or closing movement of the furniture flap 2. The actuating arm 3 can thus satisfy the constraints imposed, for example, by the kinematics of the assembly composed of furniture fitting 10 and piece of furniture 1.

A torque can be applicable to the actuating arm 3, preferably wherein:
an electric drive unit and/or
a mechanical energy storage device
is provided in the main body 5 for this purpose.

The axes of rotation of the four joints are aligned parallel to each other.

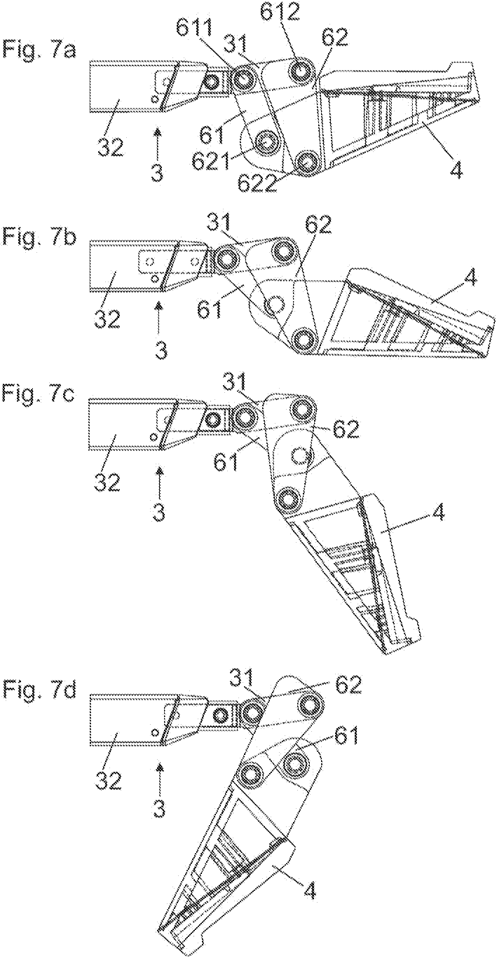

FIGS. 7a-d show the multi-joint mechanism 6 in various positions.

The actuating arm 3 comprises a connecting part 31, wherein the multi-joint mechanism 6 is connected to the at least one actuating arm 3 via the connecting part 31.

The connecting part 31 can be designed displaceable relative to the rest of the actuating arm 3. The actuating arm 3 is thus adjustable in length.

The multi-joint mechanism 6 has at least two connecting linkages 61, 62, wherein the at least one actuating arm 3 is connected to the mounting device 4 in an articulated manner by means of the at least two connecting linkages 61, 62.

The multi-joint mechanism 6 has a first connecting linkage 61 and a second connecting linkage 62, wherein:
a first joint 611 connects the actuating arm 3 to the first connecting linkage 61, and
a second joint 612 connects the actuating arm 3 to the second connecting linkage 62, and
a third joint 621 connects the mounting device 4 to the first connecting linkage 61, and
a fourth joint 622 connects the mounting device 4 to the second connecting linkage 62.

The intersection of two imaginary straight lines, which run through the axes of rotation of the first joint 611 and the third joint 621 or of the second joint 612 and the fourth joint 622 and are orthogonal to these two axes of rotation, corresponds to the position of the instantaneous center of rotation 66 of the movement of the second flap part 22 and the mounting device 4, in a reference system with a resting actuating arm 3.

In FIG. 7a, the multi-joint mechanism 6 is shown in an “extended” position. The multi-joint mechanism 6 occupies this position in a substantially closed position of the furniture flap 2.

Here, the instantaneous center of rotation lies outside the multi-joint mechanism 6.

A bending of the furniture flap 2 in the case of a substantially closed furniture flap 2 is thus avoided.

In the installed state, the instantaneous center of rotation lies in the interior of the furniture carcass 11, preferably in the rear two-thirds of the furniture carcass 11, particularly preferably in the rear third of the furniture carcass 11, or behind the furniture carcass 11.

In FIGS. 7b, c, the multi-joint mechanism 6 is shown in intermediate positions. In the case of a substantially open furniture flap 2, the multi-joint mechanism 6 occupies the position shown in FIG. 7d.

In FIGS. 7b-d, the instantaneous center of rotation lies in the region of the multi-joint mechanism 6, in particular in the region of the second connecting linkage 62.

The multi-joint mechanism 6 thus behaves like a single-joint hinge in the intermediate positions and in the case of a substantially open furniture flap 2.

In all positions of FIGS. 7a-d, in the reference system of a resting actuating arm 3, the instantaneous center of rotation of the movement of the second flap part 22 and the mounting device 4 is arranged on a first side of an installation plane of the second flap part 22, wherein the at least one actuating arm 3 and the at least one multi-joint mechanism 6 are likewise arranged on the first side of the installation plane.

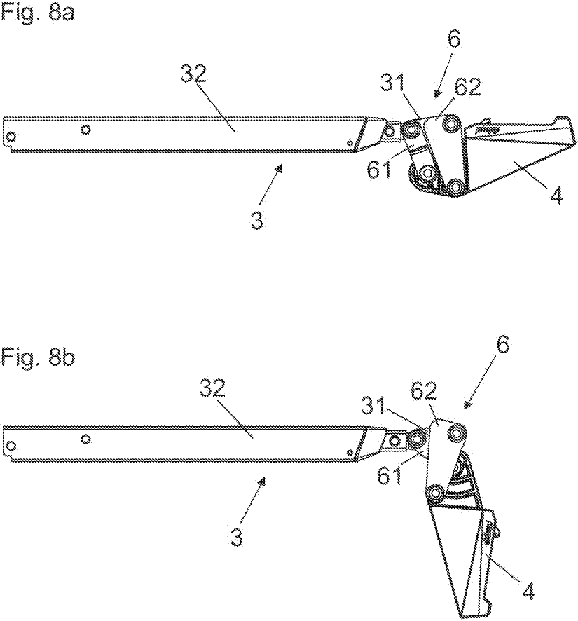

FIGS. 8a, b show the furniture fitting 10 without the main body 5. In FIG. 8a, the multi-joint mechanism 6 is shown in an “extended” position and in FIG. 8b the multi-joint mechanism 6 is shown in a folded position.

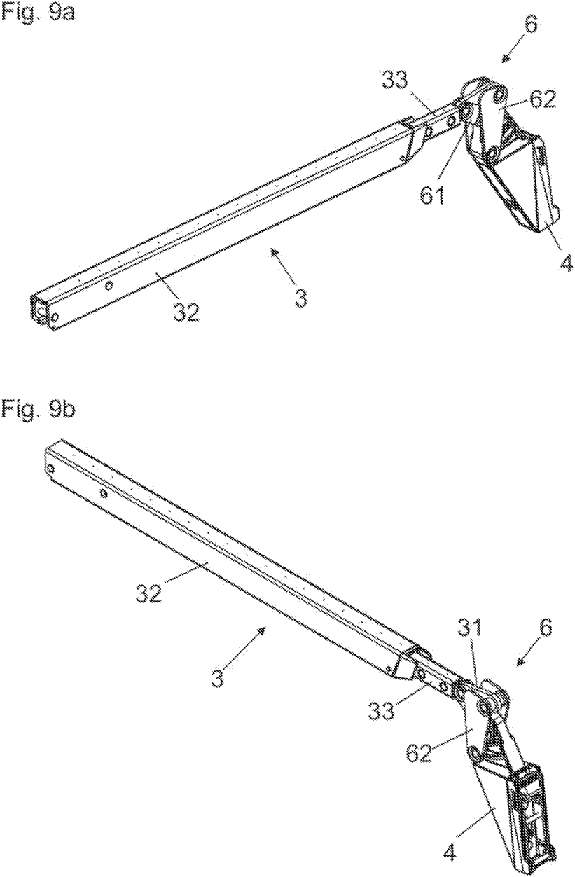

FIGS. 9a, b show the furniture fitting 10 without the main body 5 in a folded position in two different perspective representations.

FIG. 10 shows an exploded representation of the furniture fitting 10.

The multi-joint mechanism 6 comprises two connecting linkages 61, 62, wherein the two connecting linkages 61, 62 each comprise two levers 63 and wherein the levers 63 each have two drilled holes 64.

A first joint 611 of the multi-joint mechanism 6 is formed as a drilled hole 64 in the connecting part 31, a drilled hole 64 in the two levers 63 of the first connecting linkage 61 and a pin 65.

A second joint 612 of the multi-joint mechanism 6 is formed as a drilled hole 64 in the connecting part 31, a drilled hole 64 in the two levers 63 of the second connecting linkage 62 and a pin 65.

A third joint 621 of the multi-joint mechanism 6 is formed as a drilled hole 64 in the mounting device 4, a drilled hole 64 in the two levers 63 of the first connecting linkage 61 and a pin 65.

A fourth joint 622 of the multi-joint mechanism 6 is formed as a drilled hole 64 in the mounting device 4, a drilled hole 64 in the two levers 63 of the second connecting linkage 62 and a pin 65.

The connecting part 31 and the mounting device 4 are arranged between the two levers 63 of the two connecting linkages 61, 62, preferably between the two levers 63 of the two connecting linkages 61, 62 in the direction of the axes of rotation.

The multi-joint mechanism 6 is thus nested and stably constructed.

The frictional part 35, which fixes the guide sleeve 32 and the piston 33 of the actuating arm 3 in relation to each other can also be easily seen here. The fixing can be realized in combination with a spring element 34 exerting pressure on the frictional part 35.

The actuating arm 3 is detachably connected to the main body 5. For this, a main body connecting part 36 is provided, which can be connected to the guide sleeve 32 of the actuating arm 3 and can be locked to the main body 5. The actuating arm 3 can thus be easily connected to the main body 5, even if the main body 5 has already been pre-installed on the piece of furniture.

List of reference numbers:

| | | |
|---|---|---|
| 1 | piece of furniture | |
| | 10 | furniture fitting |
| | 11 | furniture carcass |
| | 12 | furniture side wall |
| | 13 | top panel |
| | 14 | base |
| 2 | furniture flap | |
| | 21 | first flap part |
| | 22 | second flap part |
| | 23 | lower edge of the second flap part |
| 3 | actuating arm | |
| | 31 | connecting part |
| | 32 | guide sleeve |
| | 33 | piston |
| | 34 | spring element |
| | 35 | frictional part |
| | 36 | main body connecting part |
| 4 | mounting device | |
| 5 | main body | |
| | 51 | actuating arm joint |
| 6 | multi-joint mechanism | |
| | 60 | joint |
| | | 611 first joint |
| | | 612 second joint |
| | | 621 third joint |
| | | 622 fourth joint |
| | 61 | first connecting linkage |
| | 62 | second connecting linkage |
| | 63 | lever |
| | 64 | drilled hole |
| | 65 | pin |
| | 66 | instantaneous center of rotation |
| 7 | flap-to-flap hinge | |
| | 71 | axis of rotation of the flap-to-flap hinge |
| | 72 | hinge cup |
| | 73 | hinge arm |
| | 74 | socket |
| 8 | actuating arm-to-flap hinge | |
| 9 | carcass-to-flap hinge | |

1. A furniture fitting for movably mounting an in particular two-part furniture flap on a furniture carcass, comprising:
a main body which is or can be connected to the furniture carcass,
a mounting device which is or can be connected to the furniture flap, and
at least one, in particular exactly one, actuating arm which is or can be mounted on the main body at a first end pivotable about an axis of rotation,
wherein the at least one actuating arm is or can be connected to the mounting device at a second end opposite the first end via at least one multi-joint mechanism, wherein the at least one multi-joint mechanism has at least three, preferably at least four, particularly preferably exactly four, joints each having one axis of rotation.

2. The furniture fitting according to claim 1, wherein the axes of rotation of the at least three joints are aligned parallel to each other.

3. The furniture fitting according to claim 1, wherein the at least one multi-joint mechanism has at least two, preferably exactly two, connecting linkages, wherein the at least one actuating arm is connected to the mounting device in an articulated manner by means of the at least two connecting linkages.

4. The furniture fitting according to claim 1, wherein the at least one multi-joint mechanism has a first connecting linkage and a second connecting linkage, wherein:
a first joint connects the at least one actuating arm to the first connecting linkage and/or
a second joint connects the at least one actuating arm to the second connecting linkage and/or
a third joint connects the mounting device to the first connecting linkage and/or
a fourth joint connects the mounting device to the second connecting linkage.

5. The furniture fitting according to claim 1, wherein:
in the case of a first – preferably extended – position of the at least one multi-joint mechanism, in the reference system of a resting actuating arm, an instantaneous center of rotation of the movement of the mounting device lies outside the at least one multi-joint mechanism in the installed position of the at least one furniture fitting, in particular in the interior of the furniture carcass, preferably in the rear two-thirds of the furniture carcass, particularly preferably in the rear third of the furniture carcass, or behind the furniture carcass, and/or
in the case of a second – preferably folded – position of the at least one multi-joint mechanism, in the reference system of a resting actuating arm, an instantaneous center of rotation of the movement of the mounting device lies in the region of the at least one multi-joint mechanism.

6. The furniture fitting according to claim 1, wherein the at least one actuating arm comprises a connecting part, wherein the at least one multi-joint mechanism is connected to the at least one actuating arm via the connecting part.

7. The furniture fitting according to claim 1, wherein the at least one multi-joint mechanism comprises at least two connecting linkages, wherein the at least two connecting linkages each comprise at least one – preferably exactly two – levers and wherein in particular the at least one lever has at least two drilled holes.

8. The furniture fitting according to claim 6, wherein:
a first joint of the at least one multi-joint mechanism is formed as a drilled hole in the connecting part, a drilled hole in the at least one lever of the first connecting linkage and a pin, and/or
a second joint of the at least one multi-joint mechanism is formed as a drilled hole in the connecting part, a drilled hole in the at least one lever of the second connecting linkage and a pin, and/or
a third joint of the at least one multi-joint mechanism is formed as a drilled hole in the mounting device, a drilled hole in the at least one lever of the first connecting linkage and a pin, and/or
a fourth joint of the at least one multi-joint mechanism is formed as a drilled hole in the mounting device, a drilled hole in the at least one lever of the second connecting linkage and a pin.

9. The furniture fitting according to claim 1, wherein the at least one actuating arm has a connecting part and the at least one multi-joint mechanism has at least two connecting linkages, wherein the at least two connecting linkages comprise at least two – preferably exactly two –levers, wherein the connecting part and/or the mounting device is/are arranged between the two levers of the at least two connecting linkages, preferably between the two levers of the at least two connecting linkages in the direction of the axes of rotation.

10. The furniture fitting according to claim 1, wherein the at least one actuating arm is adjustable in length, preferably wherein:
the length of the at least one actuating arm is fixable in particular by a catch function and/or by a frictional part, in particular in combination with a spring element exerting pressure on the frictional part, and/or by locking, in particular by means of at least one screw, and/or
the length of the at least one actuating arm is changeable during the opening and/or closing movement of the furniture flap, and/or
the at least one actuating arm has a guide sleeve and a piston, wherein the piston is displaceable in the guide sleeve, and/or
the at least one actuating arm has a connecting part, wherein the connecting part is displaceable relative to the rest of the at least one actuating arm.

11. The furniture fitting according to claim 1, wherein a torque can be applied to the at least one actuating arm, preferably wherein:
an electric drive unit, and/or
a mechanical energy storage device,
is provided in the main body for this purpose.

12. A piece of furniture with a furniture carcass, at least one in particular two-part furniture flap and the furniture fitting according to claim 1, wherein the at least one mounting device is installed on the at least one furniture flap, and wherein the at least one main body is connected to the furniture carcass and the at least one actuating arm is connected to the at least one mounting device by the at least one multi-joint mechanism.

13. The piece of furniture according to claim 12, wherein the at least one furniture flap comprises a first flap part – preferably arranged at the top in the installed position – and a second flap part – preferably arranged at the bottom in the installed position, wherein
the first flap part is connected to the furniture carcass in an articulated manner and/or the first flap part is connected to the second flap part in an articulated manner.

14. The piece of furniture according to claim 13, wherein the at least one mounting device is installed on the second flap part, wherein the at least one actuating arm is connected to the second flap part by means of the at least one multi-joint mechanism, preferably leaving out the first flap part.

15. The piece of furniture according to claim 13, wherein:
in a substantially closed position of the at least one furniture flap, the at least one actuating arm is substantially parallel to the first flap part and to the second flap part and/or
in a substantially open position of the at least one furniture flap, the at least one actuating arm is at an angle of from 45° to 135° to the second flap part.

16. The piece of furniture according to claim 13, wherein the piece of furniture is formed such that:
in a substantially closed position of the at least one furniture flap, in the reference system of a resting actuating arm, an instantaneous center of rotation of the opening movement of the second flap part lies in the interior of the furniture carcass, preferably in the rear two-thirds of the furniture carcass, particularly preferably in the rear third of the furniture carcass, or behind the furniture carcass, in particular lies outside the at least one multi-joint mechanism, and/or
in a substantially open position of the furniture flap, in the reference system of a resting actuating arm, an instantaneous center of rotation of the closing movement of the second flap part lies in the region of the at least one multi-joint mechanism.
